(19) United States
(12) Patent Application Publication
(10) Pub. No.: US 2009/0211276 A1
(43) Pub. Date: Aug. 27, 2009

(54) SYSTEM AND METHOD FOR MANAGING WATER CONTENT IN A FLUID

(76) Inventor: Dan Forkosh, Atlit (IL)

Correspondence Address: BROOKS KUSHMAN P.C., 1000 TOWN CENTER, TWENTY-SECOND FLOOR, SOUTHFIELD, MI, 48075, US

(21) Appl. No.: 11/909,521

(22) PCT Filed: Mar. 24, 2006
(86) PCT No.: PCT/IB06/01947

§ 371 Date: Jun. 12, 2008

Related U.S. Application Data
(60) Provisional application No. 60/665,304, filed on Mar. 25, 2005.

(51) Int. Cl. F25D 17/04; F25D 23/00; F25B 7/00; B60H 1/32

(52) U.S. Cl. 62/94; 62/271; 62/335; 62/239

(57) ABSTRACT

A system and method for managing water content in a fluid includes a collection chamber for collecting water from the fluid with a desiccant, and a regeneration chamber for collecting water from the desiccant. An evaporator is used to cool the collection chamber, and a compressor is used to compress refrigerant flowing through the evaporator. An engine powers the compressor, and also provides waste heat to the regeneration chamber to increase the amount of water expelled from the desiccant. Water from the desiccant is evaporated in air flowing through the regeneration chamber. Air leaving the regeneration chamber is cooled to extract the water for drinking or other uses.

### CROSS-REFERENCE TO RELATED APPLICATIONS

This application claims the benefit of U.S. Provisional Application Ser. No. 60/665,304, filed Mar. 25, 2005, which is hereby incorporated herein by reference.

### BACKGROUND OF THE INVENTION

1. Field of the Invention

The present invention relates a system and method for managing water content in a fluid, and in particular, in a fluid such as air.

2. Background Art

Conventionally, water is collected from air, or other gaseous fluids, using condensation systems. An exemplary condensation system provides a surface cooled to a temperature that is at or below the dew point of incoming air. As is well known in the art, the cooling of air at or below its dew point causes the condensation of water vapor from the air and a decrease in the absolute humidity of the air. The humidity of a volume of air is substantially determinative of the amount of water that can be introduced into, or removed from, the volume of air.

Existing water generation and removal systems collect water vapor from incoming airflows using conventional condensation systems that lower the temperature of incoming air to a temperature that is at or below the dew point of the air. Therefore, the quantity of water produced by such systems depends on the humidity of the ambient air. The humidity and temperature of air varies, however, from region to region, with hot and humid air in tropical and semi-tropical regions, and cooler, less humid air in other parts of the world. The temperature and water vapor content of air also varies widely with seasonal weather changes in regions throughout the year. Therefore, depending on the region of the world, and depending on the time of year, humidification or dehumidification may be desirable, for example, to make an environment more comfortable.

In addition to increasing comfort, management of the amount of water in air may be important to industrial applications. Moreover, it may be desirable to remove water from air so that the water can be utilized, for example, for drinking, or in other applications where fresh water is desired. Regardless of the reason for managing the amount of water in the air, there are times when conventional water management systems have undesirable limitations. For example, when the dew point of the air is low, particularly when it is below the freezing point of water, it may be difficult or impossible to remove the water using a conventional system. Moreover, conventional systems which provide cooling to extract water from air, may also generate heat that is not be utilized, and is therefore lost as wasted energy. Even if the heat is utilized, however, it is often too little to provide much benefit, since the major source of heat in some systems is a compressor used in a cooling cycle.

Therefore, there is a need for a system and method for managing the water content in a fluid that can extract water from the fluid even when the dew point is low, and can utilize waste heat from a heat source.

### SUMMARY OF THE INVENTION

The present invention provides a system and method for removing water from a fluid even when the dew point is low.

The invention also provides a system and method for removing water from a fluid utilizing waste heat from an engine which can be used to drive a compressor in a cooling cycle, and can also be used to provide power output, for example, to operate a vehicle or an electrical generator.

The present invention can be used to provide collection of water from air, with any desiccant equipment, while at the same time using waste heat from an engine. The engine can be of the type used to power a vehicle, for example, a military vehicle. In such a case, the present invention can be a mobile system that is contained within the vehicle, and can be used to provide environmental management, as well as water production capabilities. Instead of being used in a vehicle, the engine could be used to operate other equipment or machinery, for example an electrical generator. In addition to operating a vehicle, generator, or other system, the engine can also be used to power a compressor. Such a compressor can be mounted to, or otherwise mechanically connected to, the engine. Alternatively, the engine may drive a generator, which is used to supply electricity to operate the compressor. The compressor, in turn, can be used as part of a refrigeration cycle which can be used to provide cooling to one or more parts of the water management system of the present invention.

The present invention can also provide a system for extracting water from air, or for dehumidifying the air. This system includes a collection desiccant chamber wherein a solid desiccant or desiccant solution is exposed to physical contact with a first air stream, and wherein diluted desiccant is produced. Also provided is a desiccant regeneration chamber which is exposed to waste heat from an engine. The desiccant is warmed in the second chamber, and is exposed to physical contact with a second air stream. As an alternative to exposure to the second air stream, the second chamber may be a sealed regeneration chamber from which water is rejected. A compressor is mounted on the engine, and one or more evaporators are used in a refrigeration cycle. The evaporator or evaporators can be located in the collection chamber or in both the regeneration and collection chambers. The evaporators can be used to provide cooling to a liquid and/or solid desiccant material in the collection chamber. Alternatively, the evaporator or evaporators can be used to provide cooling to the air leaving the regeneration chamber, which facilitates water extraction from the air. Of course, the evaporator or evaporators can be used to provide cooling to the air leaving the collection chamber, thereby providing additional cooling to the already dry air.

The present invention also provides a system and method for passing ambient air into a first chamber having a suitable desiccant material therein. The desiccant absorbs or adsorbs moisture from the air that comes in contact with the desiccant. In one embodiment, the air contacts desiccant by pumping air through 5 a contact surface, such as a sponge, media, cooling coil, or cooling tower, that has desiccant dispersed therein. The desiccant and/or first chamber may be cooled to enable the more efficient transfer of water from the air to the desiccant. The desiccant absorbs or adsorbs water from the air, thereby transferring latent heat from the air as the water undergoes a phase change and condenses out of the air. Because the desiccant and/or first chamber are cooled, sensible cooling—i.e., cooling that is not based on a change of state—is also provided to the air. The resulting dry, cooled air is drawn out from the first chamber.

The now hydrous desiccant collects at the bottom of the first chamber and gets transferred to a second chamber. The second chamber transfer occurs either through active pumping or diffusion via a valve opening provided in a partition between the first and the second chambers. The valve opening enables equalization of desiccant levels in the first and the second chamber. The net flow of hydrous desiccant occurs from the first chamber to the second chamber until the level of the desiccant equalizes in the two chambers. The diffused or pumped hydrous desiccant in the second chamber can be heated and then again exposed to air. In one embodiment, the desiccant is sprayed into the interior of the second chamber. A heat exchanger such as a heating element warms the spray of hydrous desiccant falling from the nozzles, thereby evaporating moisture absorbed or adsorbed into the desiccant, generating hot humid air, and also regenerating substantially anhydrous desiccant.

The desiccant can be introduced into the chambers by any method effective to achieve the desired result. For example, the first chamber may include spongy cellulose material through which the hydrated desiccant percolates down to collect at the bottom of the chamber. Alternatively, the desiccant is made to simply drip in the form of drops from points within, such as the top of, the first and second chambers.

The present invention can also utilize the temperature differential between the dry air coming out of the first chamber and the hotter and humid air manufactured in the second chamber, to effect a transfer of thermal energy between the two air streams without bringing them into physical contact with each other. For example, a heat exchanger, such as a radiator-type heat exchanger comprising a plurality of tubing or pipes, can be used to bring two air streams into thermal contact. The hotter and more humid air from the second chamber can be passed through the radiator, while the relatively cool, dry air contacts the outer surfaces of the radiator via a duct that draws in the dry air from the first chamber. This results in condensation of water vapor in the heat exchanger into liquid water that drips down to collect in a condensate collector. Alternatively, the hot humid air can be directed to contact the dew-forming surfaces of a heat absorber, such as an evaporator, that are cooled using a suitable cooling process such as classic boiling fluids contained in tubes, thermoelectric elements, heat pipes, refrigerant-expansion coils or any other system known to persons of ordinary skill in the art. The water so collected can then be processed to produce potable water, or used for other purposes where water is desired.

The invention further provides a system for managing water content in a fluid. The system includes a first chamber having an inlet and an outlet for facilitating movement of a first fluid into and out of the first chamber. A desiccant is capable of being introduced into the first chamber for removing water from the first fluid moving through the first chamber. A second chamber is configured to receive at least a portion of the desiccant after it removes water from the first fluid. The second chamber includes an inlet and an outlet for facilitating movement of a second fluid into and out of the second chamber for removing water from the desiccant in the second chamber. An evaporator is configured to receive a third fluid therethrough, which at least partially evaporates as it passes through the evaporator. A compressor is operable to compress the third fluid after it leaves the evaporator. An engine is operable to provide power to operate the compressor, and a heat exchanger is configured to receive heat rejected by the engine and to transfer heat into the second chamber. This increases the temperature of the second fluid moving through the second chamber.

The invention also provides a method for managing water content in a fluid using a system which includes a desiccant and an engine. The method includes removing water from a first fluid using a process that includes exposing at least some of the first fluid to the desiccant, thereby increasing the water content of at least some of the desiccant. At least some of the desiccant having increased water content is introduced into a second fluid, thereby facilitating evaporation of water from the desiccant into the second fluid, and increasing water content of the second fluid. The engine is operated, thereby generating heat. Heat from the engine is transferred to the second fluid, thereby increasing a temperature of the second fluid.

### BRIEF DESCRIPTION OF THE DRAWINGS

FIG. 1 shows a schematic diagram of one embodiment of a system in accordance with the present invention, including an engine used to operate a compressor;

FIG. 2 shows a schematic representation of an engine and generator arrangement operable to generate electricity to operate a compressor, such as the compressor shown in FIG. 1;

FIG. 3 shows a schematic diagram of another embodiment of a system in accordance with the present invention; and

FIG. 4 shows a third embodiment of a system in accordance with the present invention, wherein the system is mounted in a vehicle and utilizes waste heat from the vehicle engine.

### DETAILED DESCRIPTION OF THE PREFERRED EMBODIMENT(S)

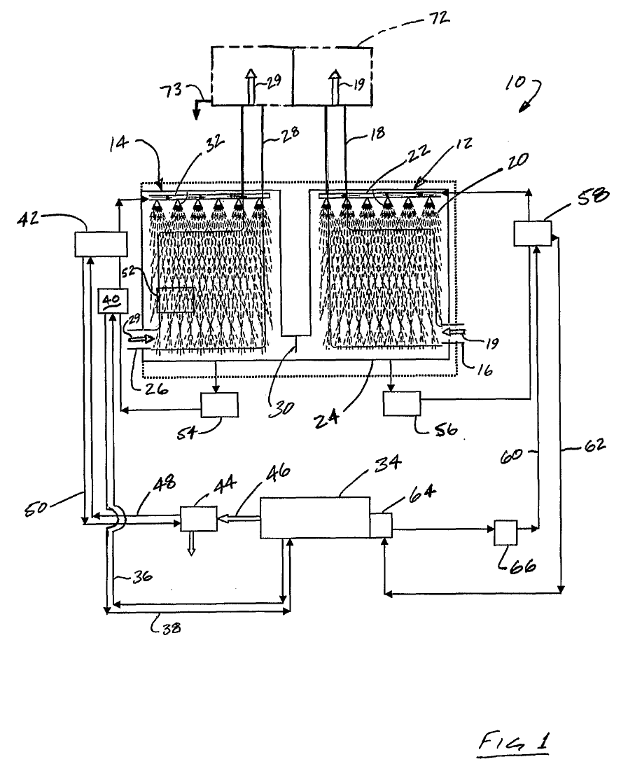

FIG. 1 shows a system 10 for managing water content in a Fluid—and in particular, air—in accordance with one embodiment of the present invention. It is worth noting that as used herein without additional limitation, “fluid” includes a liquid, a gas, or any combination thereof. The system 10 includes a first chamber, or collection chamber 12, and a second chamber, or regeneration chamber 14. The collection chamber 12 includes an inlet 16 and an outlet 18 which allow a first fluid, or a first airflow 19, to flow through the collection chamber 12. As the air flows through the collection chamber 12, it contacts a desiccant 20, which, in the embodiment shown in FIG. 1, is sprayed into the chamber 12 via a conduit 22.

As the air moves through the collection chamber 12, vaporized water is condensed out, and collects with the desiccant 20 in the bottom portion 24 of the chamber 12. The desiccant 20 is diluted as it adsorbs or absorbs the water from the air. Although the desiccant 20 shown in FIG. 1 is a liquid, the present invention contemplates the use of solid desiccants, or dual phase desiccants—e.g., solid and liquid. Any desiccant material effective to produce the desired result may be used, for example, lithium chloride.

The regeneration chamber 14 also has an inlet 26 and an outlet 28 that allow a second fluid, or a second airflow 29, to flow through the chamber 14.

Between the two chambers is a partition 30, which allows the hydrous desiccant from the collection chamber 12 to mix with desiccant in the regeneration chamber 14, and vice versa. As shown in FIG. 1, the desiccant 20 is introduced into the regeneration chamber 14 via a conduit 32, from which it is sprayed. The desiccant 20 sprayed in the regeneration chamber 14 also contacts air flowing through the chamber 14, which absorbs water from the desiccant 20, thereby regenerating the desiccant 20 for use in the collection chamber 12.

As described above, the present invention can utilize waste heat from a heat source, such as an engine 34, to improve the water management. The engine 34 utilizes a liquid coolant to reduce its temperature. As shown in FIG. 1, the system 10 takes advantage of the heat rejected by the engine 34 to the coolant to heat the desiccant 20 prior to its introduction into the regeneration chamber 14. Conduits 36, 38 allow the engine coolant to pass through a first heat exchanger 40. The heat exchanger 40 may be a primary or secondary heat exchanger for the engine coolant. Moreover, as explained more fully below, a first heat exchanger in a system, such as the system 10, need not utilize engine coolant to transfer engine heat. For example, a first heat exchanger could utilize heat from engine exhaust gas, either directly, or though an intermediate fluid.

In addition to the heat exchanger 40, the system 10 also includes a second heat exchanger 42 to further heat the desiccant 20 prior to its introduction into the regeneration chamber 14. The heat exchanger 42 receives a second heat exchanger fluid from an exhaust gas heat exchanger 44, which uses exhaust gas 46 from the engine 34 to heat the fluid. Conduits 48, 50 facilitate flow of the fluid between the heat exchangers 42, 44. The cooling water leaving the engine 34 may be in the neighborhood of 90° C., while the exhaust gases may be in the range of 400°-500° C. The heat exchanger 40 is a low temperature heat exchanger where the desiccant 20 is initially heated, and the heat exchanger 42 is a high temperature heat exchanger where the desiccant 20 can pick up even more heat. Thus, in the embodiment shown in FIG. 1, heat is transferred form the engine 34 to the second airflow 29 indirectly, through the two heat exchangers 40, 42. Heating the desiccant 20 facilitates heating of the air as it passes through the regeneration chamber 14, which increases the amount of water removed from the desiccant 20.

Although the present invention need not utilize two heat exchangers as shown in FIG. 1, this arrangement can be very effective for heating the desiccant 20 before it enters the regeneration chamber 14. In other embodiments, however, a single heat exchanger can be used to transfer heat from an engine. For example, a heat exchanger utilizing engine coolant can be used exclusively. Alternatively, a heat exchanger utilizing engine exhaust gas can be used—either exclusively, or as an intermediate heat exchanger. In FIG. 1, the exhaust gas heat exchanger 44 is an intermediate heat exchanger, first transferring heat to the second heat exchanger fluid, which facilitates heat transfer from the second heat exchanger fluid to the desiccant in the second heat exchanger 42. When used exclusively, an exhaust gas heat exchanger can be configured to directly transfer heat to the desiccant, which flows through the exhaust gas heat exchanger.

Also shown in FIG. 1 inside the regeneration chamber 14 is a third heat exchanger 52 which can pre-cool the air entering the regeneration chamber 14, causing water to condense out, thereby making it even dryer, and increasing its ability to absorb water from the desiccant 20. The heat exchanger 52 can be an air-to-air or air-to-liquid type. The heat exchanger 52 can also cool the air leaving the regeneration chamber 14, thereby extracting water from the air after it absorbs it from the desiccant 20. The desiccant 20 is pumped through the heat exchangers 40, 42, and through the conduit 32, by a pump 54. Similarly, a pump 56 is used to pump the desiccant 20 into the collection chamber 12.

As shown in FIG. 1, the desiccant 20 is pumped through an evaporator 58 prior to its introduction into the collection chamber 12. By cooling the desiccant 20, its ability to remove water from the air flowing through the collection chamber 12 is increased. A fluid, such as a refrigerant, is passed through the evaporator via conduits 60, 62. As it passes through the evaporator, the refrigerant at least partially evaporates, thereby absorbing heat from the desiccant 20 being pumped through the evaporator by the pump 56.

The evaporator 58 is part of a refrigeration subsystem, which also includes a compressor 64 and a condenser 66. Although not shown in FIG. 1, it is understood that a throttling device, such as an orifice or thermal expansion valve, may be included in the refrigeration subsystem, for example, in the conduit 60. As described above, the present invention efficiently uses energy produced by an engine, such as the engine 34. In the system 10, the thermal energy produced by the engine 34, and otherwise wasted, is utilized to heat the desiccant 20 prior to its entry into the regeneration chamber 14, and this increases the amount of water it can expel. In addition to thermal energy, the mechanical energy produced by the engine 34 is also efficiently utilized by the system 10. For example, the engine 34 mechanically operates the compressor which is part of the refrigeration subsystem. The mechanical work of the engine 34 is in addition to other mechanical work it can perform, such as operating a vehicle.

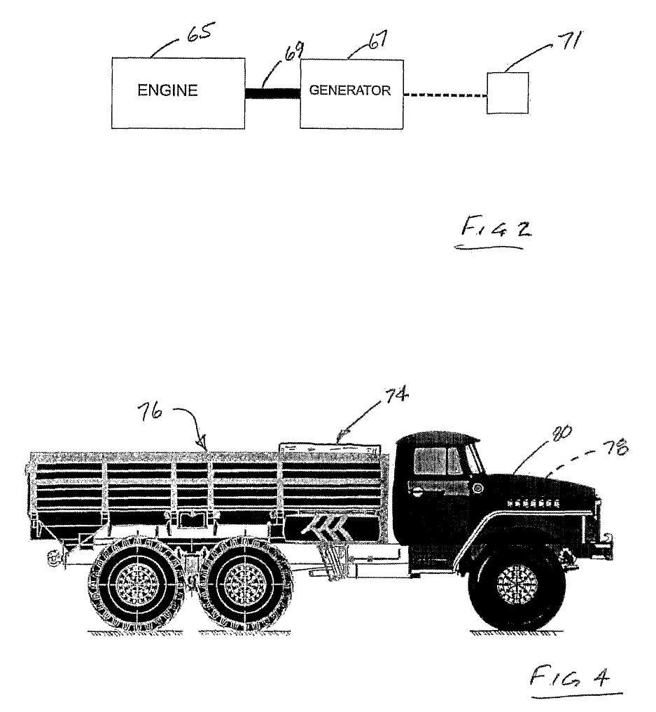

In an alternative arrangement, an engine, such as the engine 34, can mechanically drive a generator, which outputs electrical power to operate equipment, for example, a compressor. FIG. 2 shows a simple schematic representation of one such arrangement, in which an engine 65 mechanically drives a generator 67 through a shaft 69. The generator produces electricity to operate a compressor 71, which can be used in a system, such as the system 10 shown in FIG. 1.

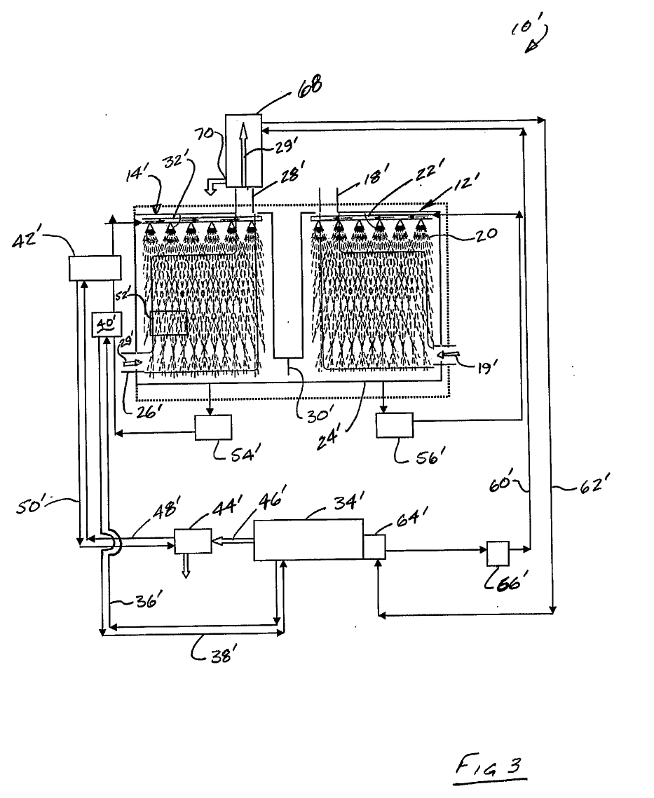

FIG. 3 shows another embodiment of the present invention. In FIG. 3, the prime symbol (′) has been used to identify elements which are related to those found in the system 10 shown in FIG. 1. Thus, FIG. 3 illustrates a system 10′ for managing the water content in air. It is worth noting that although air is used as an example, the present invention can be used to manage the water content in other gas-water mixtures. The system 10′ shown in FIG. 3, has a system heat exchanger, or evaporator 68, located at the outlet 28′ of the regeneration chamber 14′. This arrangement can be useful for extracting water from air leaving the regeneration chamber 14′. This water can be collected from an outlet 70 of the evaporator 68. The collected water can then be processed to generate potable water, or it can be used in other applications where water is desired. An evaporator, such as the evaporator 68, can also be disposed at the outlet of the collection chamber 12′, if it is desired to further cool the air as it leaves.

As described above, the present invention is not limited to a single evaporator, but rather, may include multiple evaporators to cool the desiccant 20, as well as one or both air streams. In addition, the air streams leaving the two chambers, for example, the chambers 12, 14 shown in FIG. 1, could be brought into thermal contact with each other via a system heat exchanger 72, shown in phantom, which is connected to the respective outlets 18, 28 of the chambers 12, 14. This would allow a transfer of heat from the warm, humid air leaving the regeneration chamber 14 to the dry, cool air leaving the collection chamber 12, and result in condensation of water 73 from the airflow 29.

As described above, a system for managing water content in accordance with the present invention can be a mobile system, mounted on, or otherwise contained in, a vehicle. FIG. 4 shows a system 74 mounted in the back of a military vehicle 76. The vehicle 76 is driven by an engine 78 located under a hood 80. The engine 78 can be used in the system 74 like the engine 34 is used in the system 10, shown in FIG. 1. For example, engine coolant fluid, exhaust gas from the engine 78, or both, can be used to heat an airflow in a regeneration chamber. In addition, the engine 78 can be used to operate a generator, a compressor, or both. As described in conjunction with the systems 10 and 10′ shown in FIGS. 1 and 3, water can be collected from air leaving a regeneration chamber. When this step is performed in conjunction with the system 74 shown in FIG. 4, the result is mobile water generation.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for managing water content in a fluid using a system including a desiccant and an engine, the method comprising:
removing water from a first fluid using a process that includes exposing at least some of the first fluid to the desiccant, thereby increasing the water content of at least some of the desiccant;
introducing at least some of the desiccant having increased water content into a second fluid, thereby facilitating evaporation of water from the desiccant into the second fluid and increasing water content of the second fluid;
operating the engine, thereby generating heat; and
transferring heat from the engine to the second fluid, thereby increasing a temperature of the second fluid.

2. The method of claim 1, further comprising removing water from the second fluid after its water content is increased.

3. The method of claim 1, the system further including a compressor and an evaporator, wherein the step of operating the engine provides power to operate the compressor, the method further comprising:
operating the compressor to compress a third fluid;
passing the third fluid through the evaporator such that the third fluid at least partially evaporates; and
passing the first fluid through the evaporator, thereby transferring heat from the first fluid to the third fluid and lowering a temperature of the first fluid.

4. The method of claim 3, wherein the step of operating the engine includes mechanically driving the compressor with the engine.

5. The method of claim 3, the compressor being connected to a generator, wherein the step of operating the engine includes driving the generator with the engine, thereby generating electrical power to operate the compressor.

6. The method of claim 1, the system being operatively connected to a vehicle, wherein the step of operating the engine provides power to drive the vehicle.

7. The method of claim 6, further comprising removing water from the second airflow after its water content is increased, thereby resulting in mobile water generation.

8. The method of claim 1, the system further including a first heat exchanger, the method further comprising:
cooling the engine with a coolant, thereby increasing the temperature of the coolant; and
passing the coolant through the first heat exchanger, and
wherein the step of transferring heat from the engine to the second fluid includes passing the desiccant through the first heat exchanger before the desiccant is introduced into the second fluid, thereby transferring heat from the coolant to the desiccant, and facilitating transfer of heat from the desiccant to the second fluid.

9. The method of claim 1, the system further including a second heat exchanger, the method further comprising:
passing exhaust gas from the engine through an exhaust gas heat exchanger;
passing a second heat exchanger fluid through the exhaust gas heat exchanger, thereby transferring heat from the engine exhaust gas to the second heat exchanger fluid; and
passing the second heat exchanger fluid through the second heat exchanger, and
wherein the step of transferring heat from the engine to the second fluid further includes passing the desiccant through the second heat exchanger before the desiccant is introduced into the second fluid, thereby transferring heat from the second heat exchanger fluid to the desiccant, and facilitating transfer of heat from the desiccant to the second fluid.

10. The method of claim 9, the system further including a first heat exchanger, the method further comprising cooling the engine with a coolant, thereby increasing the temperature of the coolant; and
passing the coolant through the first heat exchanger, and
wherein the step of transferring heat from the engine to the second fluid includes sequentially passing the desiccant through the first heat exchanger, then the second heat exchanger.

11. The method of claim 1, further comprising removing water from the second fluid prior to introducing the desiccant into it, thereby increasing the capacity of the second fluid to receive evaporated water from the desiccant.

12. The method of claim 11, wherein the step of removing water from the second fluid prior to introducing the desiccant into it, includes cooling the second fluid to remove water through condensation.

13. A system for managing water content in a fluid, comprising:
a first chamber having an inlet and an outlet for facilitating movement of a first fluid into and out of the first chamber;
a desiccant capable of being introduced into the first chamber for removing water from the first fluid moving through the first chamber;
a second chamber configured to receive at least a portion of the desiccant after it removes water from the first fluid, the second chamber including an inlet and an outlet for facilitating movement of a second fluid into and out of the second chamber, thereby facilitating evaporation of water from the desiccant in the second chamber into the second fluid;
an engine operable to output mechanical power; and
a first heat exchanger configured to receive heat generated by the engine when it is operating, and to transfer heat to the second fluid, thereby increasing the temperature of the second fluid moving through the second chamber.

14. The system of claim 13, further comprising a system heat exchanger configured to receive the second fluid from the second chamber and to facilitate cooling of the second fluid to extract water therefrom.

15. The system of claim 13, wherein the first heat exchanger is configured to receive the desiccant after it has removed water from the first fluid, the system further comprising an engine coolant for removing heat from the engine, the coolant flowing through the first heat exchanger, thereby transferring heat from the coolant to the desiccant, and facilitating transfer of heat from the desiccant to the second fluid.

16. The system of claim 15, further comprising:
an exhaust gas heat exchanger having a second heat exchanger fluid flowing therethrough, the exhaust gas heat exchanger being configured to receive a flow of exhaust gas from the engine and to transfer heat from the exhaust gas to the second heat exchanger fluid; and
a second heat exchanger configured to receive the second heat exchanger fluid and the desiccant after the desiccant has removed water from the first fluid, thereby transferring heat from the second heat exchanger fluid to the desiccant, and facilitating transfer of heat from the desiccant to the second fluid.

17. The system of claim 16, wherein the first heat exchanger is configured to receive the desiccant from the second chamber, and the second heat exchanger is configured to receive the desiccant from the first heat exchanger.

18. The system of claim 17, further comprising a third heat exchanger configured to cool the second fluid prior to its moving through the second chamber, such that water is removed from the second fluid.

19. The system of claim 13, further comprising:
an evaporator having a third fluid flowing therethrough, and the evaporator being configured to receive the desiccant before the desiccant is introduced into the first chamber and to transfer heat from the desiccant to the third fluid; and
a compressor powered by the engine and operable to compress the third fluid after it flows through the evaporator.

20. The system of claim 19, wherein the engine is operable to mechanically drive the compressor.

21. The system of claim 19, further comprising a generator connected to the engine and the compressor, the generator being configured to be mechanically driven by the engine, and to output electricity to power the compressor.

22. The system of claim 13, wherein the first and second chambers, the engine, and the first heat exchanger are disposed within a vehicle, the engine being operable to drive the vehicle.

23. The system of claim 22, further comprising a system heat exchanger configured to receive the second fluid from the second chamber and to facilitate cooling of the second fluid to extract water therefrom, thereby resulting in a mobile water generation system.
